(19) United States
(12) Patent Application Publication
(10) Pub. No.: US 2016/0012030 A1
(43) Pub. Date: Jan. 14, 2016

(54) DATA FORM GENERATION AND GATHERING

(71) Applicants: Tuyen Tran, Nashville, TN (US); Matthew O'Neill, Nashville, TN (US); Stephen S. Hau, Nashville, TN (US); Alan Huffman, Nashville, TN (US)

(72) Inventors: Tuyen Tran, Nashville, TN (US); Matthew O'Neill, Nashville, TN (US); Stephen S. Hau, Nashville, TN (US); Alan Huffman, Nashville, TN (US)

(21) Appl. No.: 14/325,919

(22) Filed: Jul. 8, 2014

(51) Int. Cl. G06F 17/24; G06F 3/0482; G06F 3/0484

(52) U.S. Cl. CPC G06F 17/243; G06F 3/04842; G06F 3/0482

(57) ABSTRACT

A data entry form rendered on a screen display is based on a user provided form such that the appearance and field positions of the screen display simulates the paper form that is familiar to the user. The rendered form identifies field positions based on a scan of the paper form, and a Graphical User Interface receives user input for attributes for each identified field. Fields are mapped to metadata for specifying the attributes, such as data type, ranges, and manner of entry. Subsequent data entry based on the generated form provides a user experience similar to the corresponding paper form for mitigating any change in workflow or thought process based on the form. In this manner, a repeatable processes which can be reduced to templated data entry may be transformed to electronic forms without deviating from the visual cues afforded by the paper forms that the office staff and professionals have become accustomed to.

### BACKGROUND

Modern office trends often bring up the notion of a “paperless” office, in which all office workings are transacted in an electronic manner such as emails and application GUIs (Graphical User Interfaces). Mobile devices such as tablets, smartphones, and other portable devices lend themselves well to this environment. Many professionals, particular those in private practice such as doctors, lawyers, and dentists, however, have a refined set of forms that streamlines the practice and enjoys widespread acceptance among the staff as a working model. Attempts to implement an electronic infrastructure often meets with resistance because of entrenched paper or existing user interface systems due to familiarity with the status quo, a learning curve to reorient the staff and professionals, and a risk of downtime or loss should a different electronic system fail.

### SUMMARY

A data entry form rendered on a screen display is based on a user provided form such that the appearance and field positions of the screen display simulates the existing paper or UI (User Interface) form that is familiar to the user. Any suitable workflow that is codifiable to include a templated arrangement of data items or paper forms, such as business processes, retail purchasing, shipping and receiving or academic selections (i.e. course registration) to name several, may be represented by the approach herein. The rendered form identifies field positions detected by image processing techniques such as feature and edge detection, and a GUI (Graphical User Interface) receives user input for attributes for each identified field. Fields are mapped to generated or predetermined metadata for specifying the attributes, such as data type, ranges, and manner of entry (pull down, button, etc.). The predetermined metadata is based on a template or practice model of typical usages in the context with which the form is used, and additional metadata generated for fields outside the general template. Subsequent data entry based on the form provides a user experience similar to the corresponding paper or existing UI form that the users are familiar with, for mitigating any change in workflow or thought process based on the form. In this manner, a paper or existing electronic UI based business model, such as that used in an office environment, may be transformed to new electronic forms and entry without deviating from the visual cues afforded by the paper or existing UI forms that the office staff and professionals have become accustomed to.

Existing systems that rely on a set of information items in a repeatable process can be codified and represented as disclosed herein. Such existing systems may include, but are not limited to: 1. Paper forms, 2. Existing UI forms (on current systems), and 3. Workflows that can be reduced to a spatial layout of information items. The disclosed approach allows for custom creation using these existing systems as the model. Configurations herein generate a UI that will represent these existing ways of doing business without requiring much if any behavioral change. While disclosed examples depict a paper form to digital form as an example of the technology and approach, it should not be considered the only application of encompassing a workflow.

The workflow as encompassed by the disclosed approach represents a mental awareness and recognition of a spatial orientation of information as visually rendered on GUIs, paper forms, or other media employed in a workplace, enterprise, or systematic environment that adheres to established channels of information flow. The information flow and the manner of rendering on the GUIs, forms, etc. represents a mental model that individuals in the environment are accustomed to and work efficiently to.

Configurations herein are based, in part, on the observation that conventional approaches to electronic records and data entry force a user to conform to the provider's system, rather than the provider having a system that can conform to the user's business model. For example, in a medical office environment, physicians typically have particular paper or existing UI forms with fields that they have become accustomed to using and that have a particular meaning or significance to their practice. Unfortunately, conventional approaches suffer from the shortcoming that data entry forms provided by an automated system are generated by the system provider, based on speculation or estimation about what typical practices in the business space use on their forms. Generally, this is driven by a business model of the records system provider seeking to achieve maximum overlap with the practices that they seek to cater to. However, this “one size fits all” approach is likely to leave some fields omitted, and will not have the same physical appearance of the forms that the doctor and office staff have become accustomed to. Conventional approaches often force a generic, unfamiliar interface onto a user and staff.

Accordingly, configurations herein substantially overcome the shortcomings of conventional data entry services and systems by generating an onscreen form based on the practitioner's paper form, to emulate all fields used in the practice, and presented in a manner consistent with current usage. Users observe a form having fields with the same coordinate arrangement and meaning as the corresponding paper or existing UI form, and the fields are mapped to metadata to enable operations such as queries and reports based on the forms. Therefore, the care and effort that the practitioner has invested in developing, revising and tuning the form structure to their preferred manner of practice is not sacrificed by being forced or “pigeonholed” into a standard form or template designed to accommodate “most fields.”

In further detail, configurations disclosed herein provide a system, method and apparatus for gathering form data, by rendering a scanned form on a user display from a paper or captured digital rendering of the form, and receiving a selection of a field based on the paper rendering of a form. The system assigns a set of attributes for the selected field, to denote type and other aspects of the field, such that the selected field is configured for subsequent population from user input in conformance with the assigned attributes, such as in a data entry environment.

The discussion below includes an example invocation and sequence of the disclosed approach in a professional environment. The approach is applicable to any set of defined steps of gathering or reporting information, storing the information, and directing the information for subsequent review and/or consumption by a subsequent step in the environment. The approach identifies and captures the information items employed in a target environment, and transforms the information items into a computer rendered version having the same rendered appearance that users in the environment have become accustomed to. The information items (typically data fields from a templated data entry form) are stored, indexed, and cross referenced with other occurrences of the information items so that users may retrieve and employ the stored information elsewhere in the environment. The visual rendering of the information remains the same as in the preexisting environment and as gathered, stored, and reported using the disclosed approach, such that users observe a GUI rendered form having the same appearance as a preexisting paper form. In this manner, users are not forced to relearn and translate “new” fields or data items to corresponding preexisting fields, but rather retain previous training and work patterns because the visual cues and prompting provided by the preexisting forms is preserved.

The method of generating a data entry form, as discussed further below, depicts a specific example of a medical facility for facilitating transition of a paper form or existing UI based system to a new electronic form system, and includes identifying, based on a paper or digital rendering of a medical record, fields responsive to patient information, and mapping, for each of the identified fields, an association to metadata corresponding to the identified field. The metadata may be provided from a template for denoting fields typically employed in a medical facility, such as “diagnosis.” The system determines, based on the paper rendering, a screen position of each of the identified fields, typically based on a scan file from the paper or existing UI form. In operation of the resulting system, a GUI receives, from a screen position based on the defined position, the patient information corresponding to the paper rendering of the field, and gathering, from a GUI display of each rendered field, data for populating the identified field. Other examples and descriptions are given below.

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an

Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computing environment suitable for use with configurations disclosed herein;

FIG. 2 is a block diagram of form generation in the environment of FIG. 1;

FIG. 3 shows selection of a scanned form for metadata association;

FIG. 4 shows field identification in the form of FIG. 3; and

FIG. 5 is a field selection screen for identifying fields to associate to metadata;

FIG. 6 shows selection of field type for a field from FIG. 5;

FIG. 7 shows selection of attributes based on the field type of FIG. 6; and

FIGS. 8a and 8b show a flowchart of scanning and entering metadata for form development.

### DETAILED DESCRIPTION

Configurations herein disclose an example entry of a form and deriving metadata, expressed as form attributes, on a host computer system for generating the electronic forms from a set of paper or existing UI forms. The generated electronic forms may then be employed for data entry and queries on a user device such as the table mentioned above, on another suitable device operable for rendering the form and receiving the user input as described further below. Mobile devices are expected to provide a user experience similar to the paper form, as a tablet device may be carried as a conventional paper approach might employ a clipboard with paper forms. In this manner, any suitable repeatable process which can be defined in terms of a templated data entry, such as a paper based business model may be transformed to electronic forms without deviating from the visual cues afforded by the paper forms that the office staff and professionals have become accustomed to.

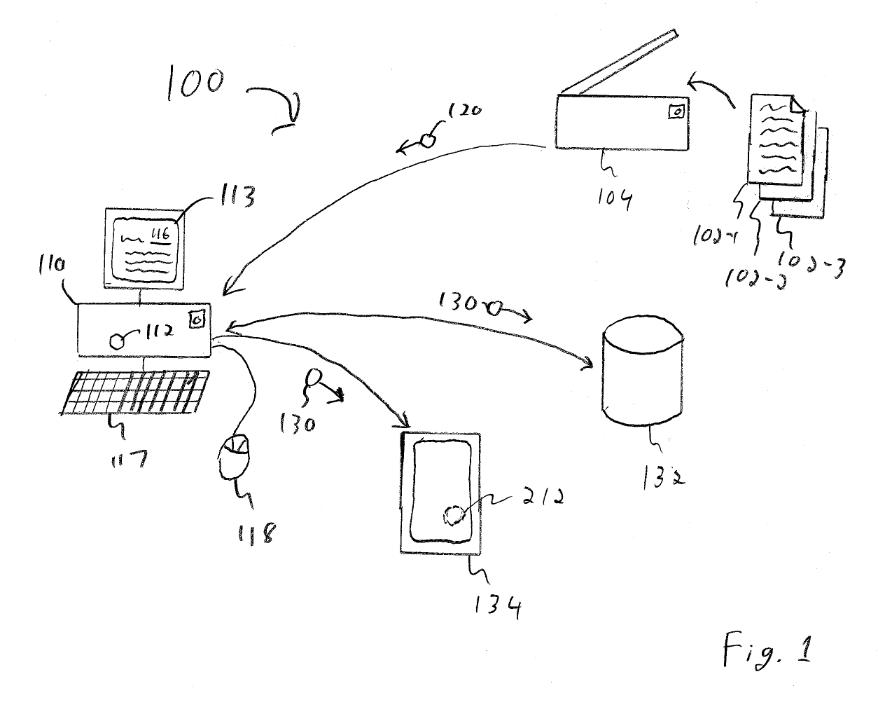

FIG. 1 is a context diagram of a computing environment 100 suitable for use with configurations disclosed herein. Referring to FIG. 1, in a data entry environment 100, a plurality of paper forms 102-1 . . . 102-N (102 generally) are often employed for various tasks. In a doctor's office, for example, forms may exist for patient personal data, patient history, diagnosis, and treatment. There may also be other forms specific to particular courses of treatment, or for expanding on particular patient history conditions. In general, a busy office may employ a number of forms used in various circumstances, creating a complex set of interrelations and dependencies on forms employed in each particular case.

A scanner or other visual input device scans the paper form 102 or a UI is captured to send a raw form image 120 to a form definition system 110. The paper form 102 is representative of a templated data entry arrangement having fields located in particular positions, usually having a significance to their location. The form definition system 110, or server, may be a standard computer, such as a PC or MAC, operable to launch and execute a forms application 112. The form definition system 110 also includes a rendering device 114 having a visual display 113 for rendering a screen image, typically a GUI 116, a keyboard 117 and a pointing device 118, as is typical. The application 112 renders a screen image 116 using the raw form image 120 representative of the paper form 102.

The application 112 employs the GUI 116 to receive user input, as discussed further below, for associating each of the fields on the form image 120 with metadata indicative of the fields to generate an electronic form (form) 130 suitable for processing, querying, and reporting data based on the form 130 as discussed further below. The form 130 may be stored in a storage repository 132, which may be a native mass storage device on the form definition system 110, and may also be emailed, printed, or otherwise transmitted around the office or enterprise environment as needed. The form 130 may also be rendered on a mobile device 134, such as tablet or phone, which may have a complementary application 212 for rendering the generated form 130 and receiving data for queries, reports, and other processing. In a particular configuration, the mobile device may be an iPad® or iPhone®, marketed commercially by Apple Computer, Inc. of Cupertino, Calif. In this manner, a complex arrangement of paper forms 102 or existing UI forms representing an office or business workflow is transferred to the forms 130 suitable for entry, storage, and queries using a mobile device 134 or other suitable computing device. Since the rendered forms 130 on the mobile device have the same appearance and content as the corresponding paper forms, a former paper system can be upgraded to mobile devices with minimal relearning, disruption, or reworking of office procedures.

An example may illustrate. Few forms are more widely known than the personal income tax statement embodied as Form 1040 of the IRS (Internal Revenue Service). This form and its counterpart dependent forms represents a highly interrelated and complex arrangement of information, and is navigated by many, both on paper and on its electronic counterparts from the IRS itself and from third party vendors. Users of these forms undoubtedly identify with a pattern of information that suits their personal situation which likely remains somewhat consistent from year to year. Such users rely on the visual cues afforded by the spatial arrangement of the fields, with right aligned numerical entries and indented sub calculations and computations amounts slightly indented from the right. Users are probably aware of a relative positioning of fields which defer to other forms, such as itemized deductions and capital gains. Imagine if a vendor attempted to market a software product that deviated from this well-established rendering of the user's personal financial data. Entry of the data and related calculations represent a workflow which is repeated in substantially the same manner year after year.

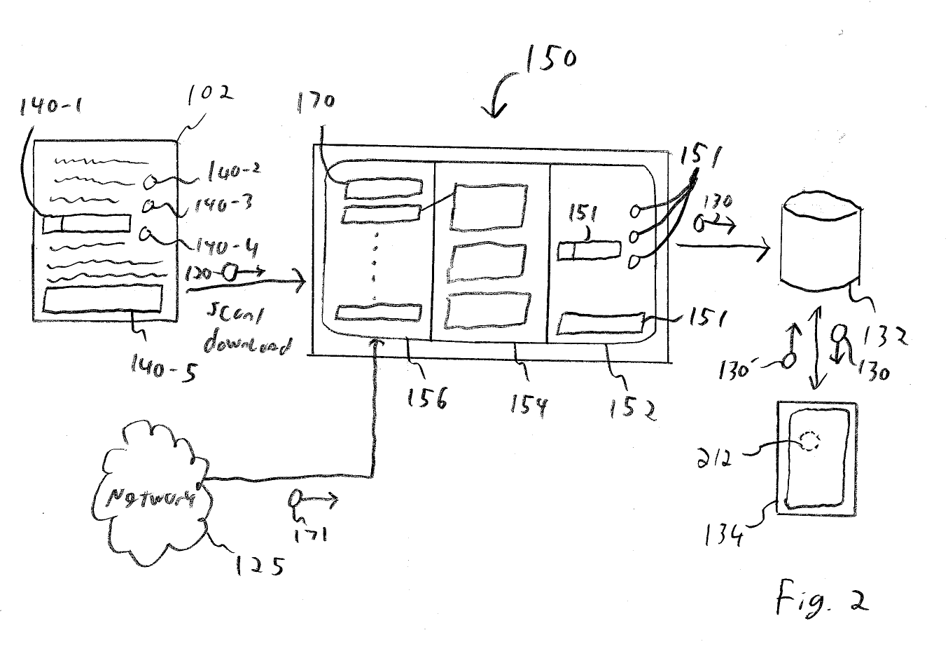

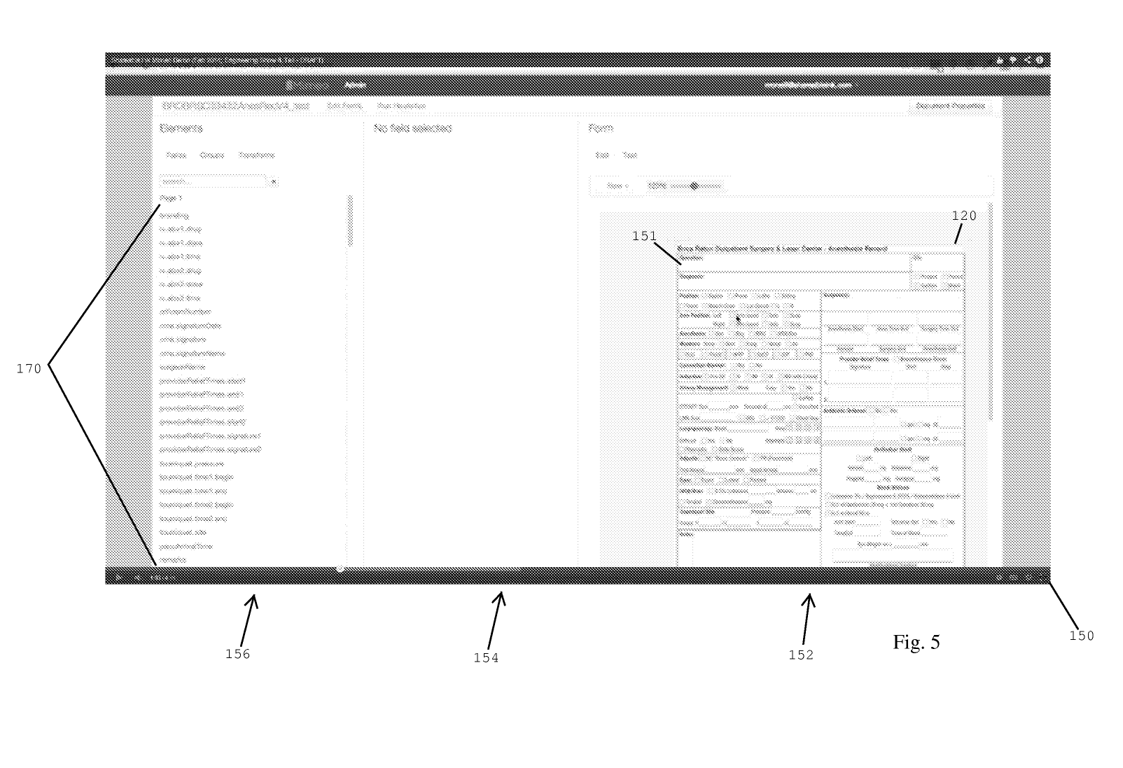

FIG. 2 is a block diagram of form generation in the environment of FIG. 1. Referring to FIGS. 1 and 2, the paper form 102 defines a number of fields 140-1 . . . 140-5 (140 generally). The fields 140 may include pulldowns 140-1, buttons 140-2, 140-3, 140-4, free form text 140-5, or any suitable data type, discussed further below. Once scanned or downloaded, the form image 120 is received by the form definition system 110 for invoking the GUI 116 with a form definition screen 150 to generate the form 130. The form definition screen 150 includes three windows: an image window 152 for displaying the form image 120 and form fields 151, an attributes window 154 for defining attributes such as data types, entry mechanisms and validation, and a field list window 156, listing available fields 170 on the form image 120. The application 112 may also attach other aspects to the fields, such as interrelations between fields, validation, or additional processing to be performed upon entry of a particular field. A user will generally iterate between the three windows 152, 154 and 156 in the course of generating the fields and metadata from the form image 120 to define the form 130, as will be discussed further in FIGS. 5-7, below.

Once the application 112 defines the form 130 by mapping the fields 151 to corresponding metadata fields 170, the form 130 may be stored in the repository 132. Further, metadata fields 170 may be provided in the form of predetermined templates 171 from a public access network 125, such as the Internet. The form 130 may also be sent to a mobile computing device 134 so that a user may populate the form and return the populated form 130′ for subsequent processing, such as queries, reports, or storage. Stated differently, the form 130 includes the visual representation contained in the raw form 120 with metadata mapping field attributes and position to the form 130.

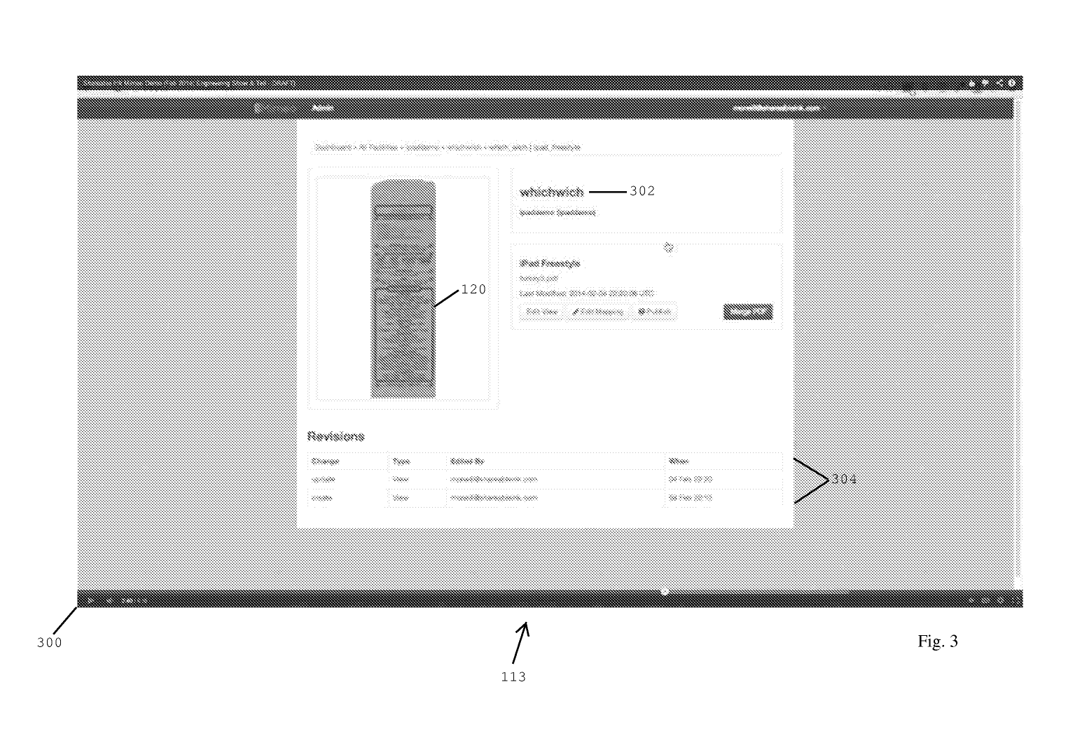

FIG. 3 shows selection of a candidate form for metadata association. The candidate form may result from scanning of a paper document, or from another GUI or other spatially significant representation of the data. Any suitable templated arrangement of information that defines a spatial layout of the information items may be employed, such as an electronic or paper rendering. Referring to FIGS. 1-3, upon scanning the paper form 102, the form image 120 is received and selected by name 302, and the application 112 displays the form image 120 on the display 113. A revision history 304 shows previous invocations of the form 120 for field selection and metadata mapping.

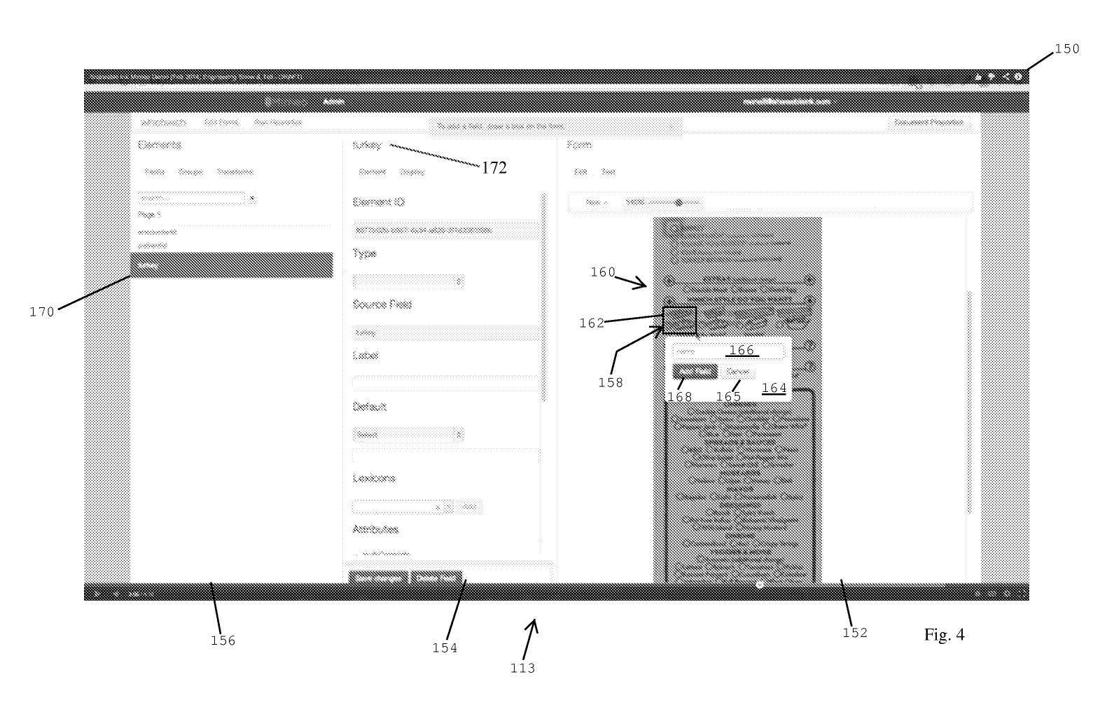

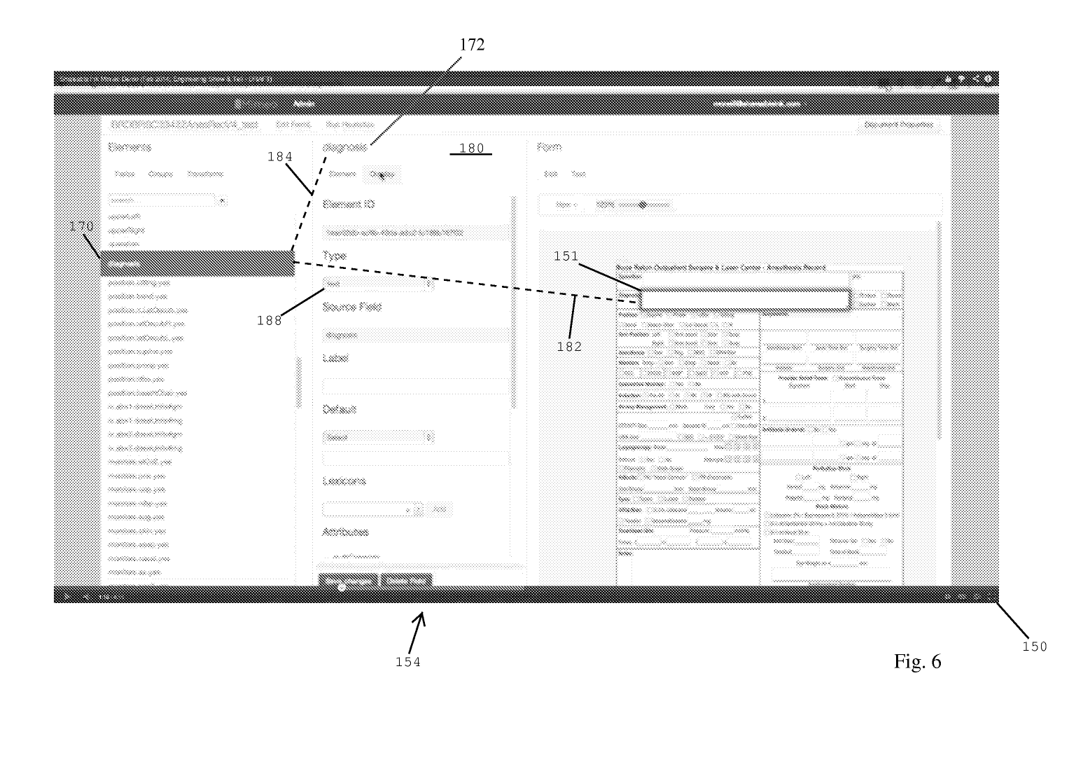

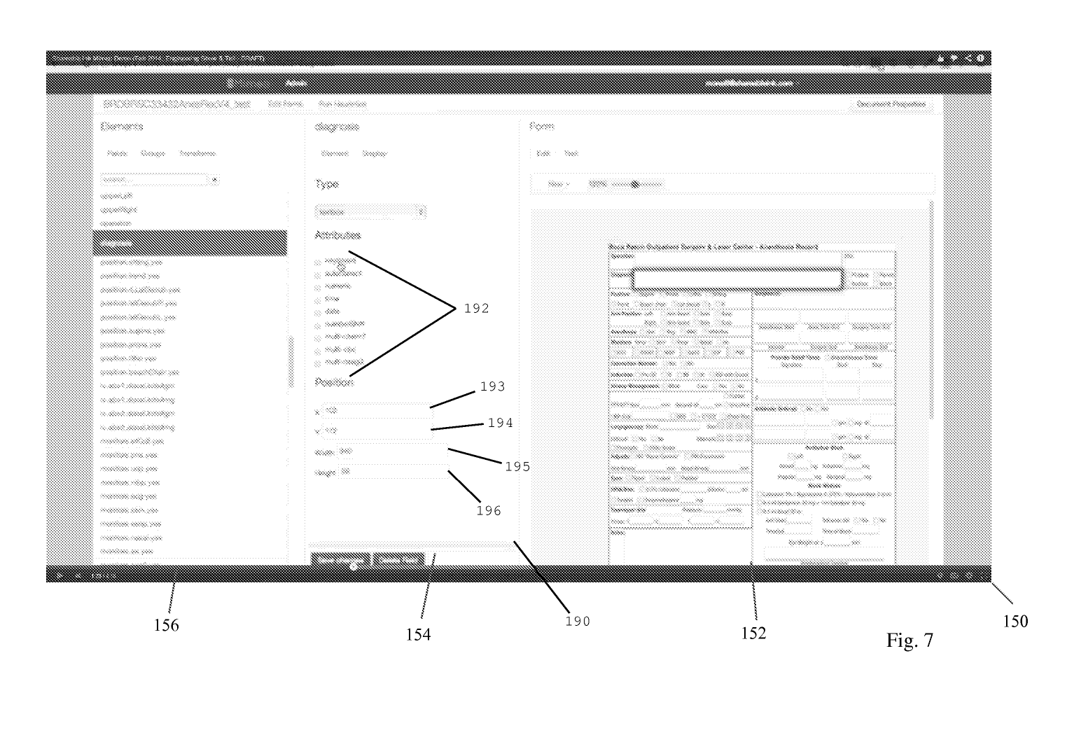

FIG. 4 shows field identification in the form of FIG. 3. Referring to FIGS. 1, 2 and 4, the display 113 renders the form definition screen 150. The form image 120 appears in the image window 152, and is accessed by a pointer 158 based on the pointing device 118. Upon hovering on a field location 160, the application 112 detects features consistent with a field, such as a box or outline, and encloses the region with a designator box 162. Having detected a potential field 151, the application 112 renders a field identification box 164 to indicate it found a graphical rendering on the raw form 120 that appears to correspond to a field 151. If the detected field location 160 is not a field, the user may click the cancel box 165, or otherwise enters a field name in the name box 166, and clicks the “add field” button 168. Upon adding the field 151, an entry 170 is created in the field list window 156, and the attributes window 154 displays the name 172 of the field 151 to indicate it is ready to receive attributes for the field 151. Attributes may be immediately entered, as will be discussed below in FIGS. 6 and 7, or all fields may be named to generate a list of field entries 170 in the field list window 156.

FIG. 5 is a field selection screen for identifying fields to associate to metadata. Referring to FIGS. 2, 3 and 5 the user invokes the form definition screen 150. The scanned form image is displayed in the form image 120. The field list window 156 displays an entry 170 for each available field 151. In particular configurations, the field list window 156 may be populated with predetermined fields from a context or practice based set representative of a domain of typically used data entries. Fields 151 on the form image 120 may either be associated to one of the predetermined fields or used to create a new entry 170. In either case, the field 151 from the form image 120 is associated with an entry 170 in the field list window 156, and is assigned attributes, as now described with respect to FIG. 6.

FIG. 6 shows selection of field type for a field from FIG. 3. Referring to FIGS. 5 and 6, upon selection of a field entry 170, an attribute selection 180 appears in the attributes window 154. The selected field 151 corresponds to the entry 170, as shown by dotted line 182, and the corresponding field name 172 is reflected in the attributes window 154, as shown by dotted line 184, depicting the mapping from the paper form 102 to the form field 151 and corresponding attributes. A type 188, such as button, pull-down, numeric, or free form text, determines additional attributes available for the field.

FIG. 7 shows selection of attributes based on the field type of FIG. 4. Referring to FIGS. 1, and 5-7, upon selection of the type 188 for the field 151, an attribute selection 190 is shown in the attributes window 154. In the example shown, a textbox type results in a range of selectable attributes 192 being displayed, along with position attributes including a horizontal “x” position 193, a vertical “y” position 194, a width 195 and a height 196. The position attributes are populated initially with the location of the designator box 162, but can be modified to broaden or narrow the designator box 162 and corresponding hovering sensitivity accordingly. The size of the designator box 162 therefore defines a sensitivity area upon which the user's pointing device (e.g. mouse 118) detects a live field 151.

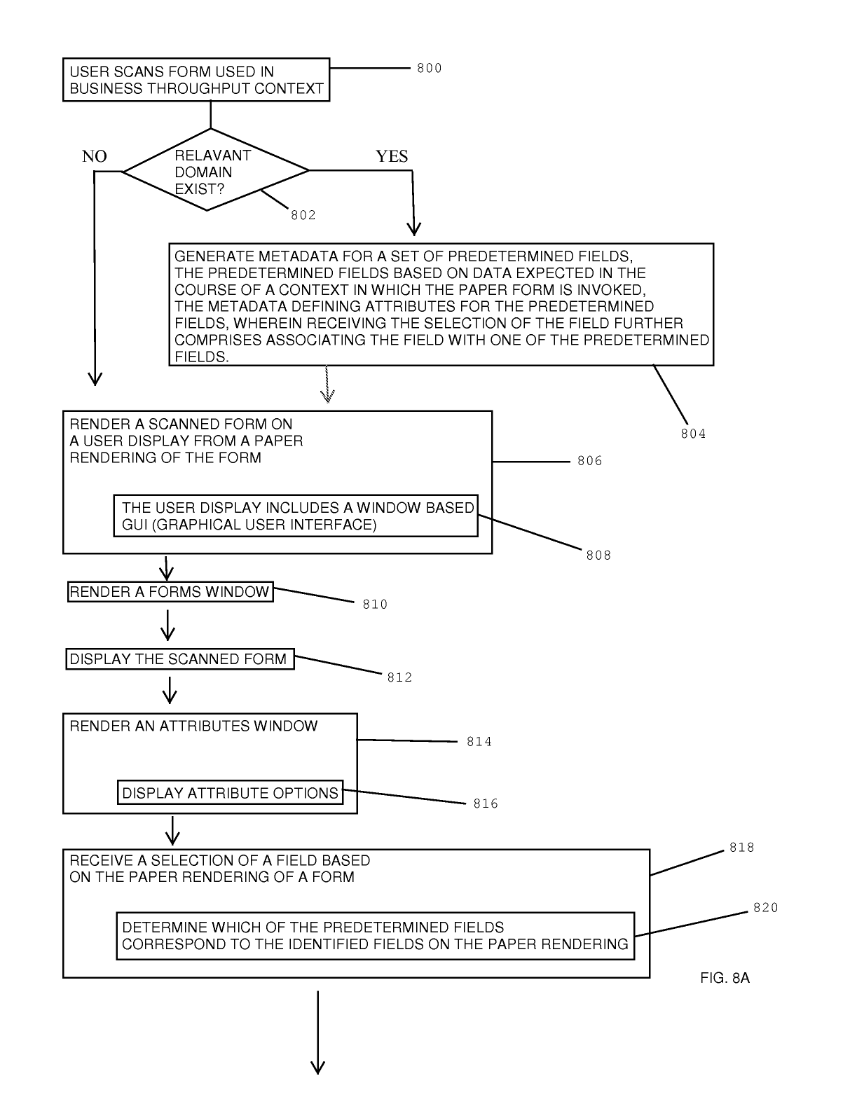

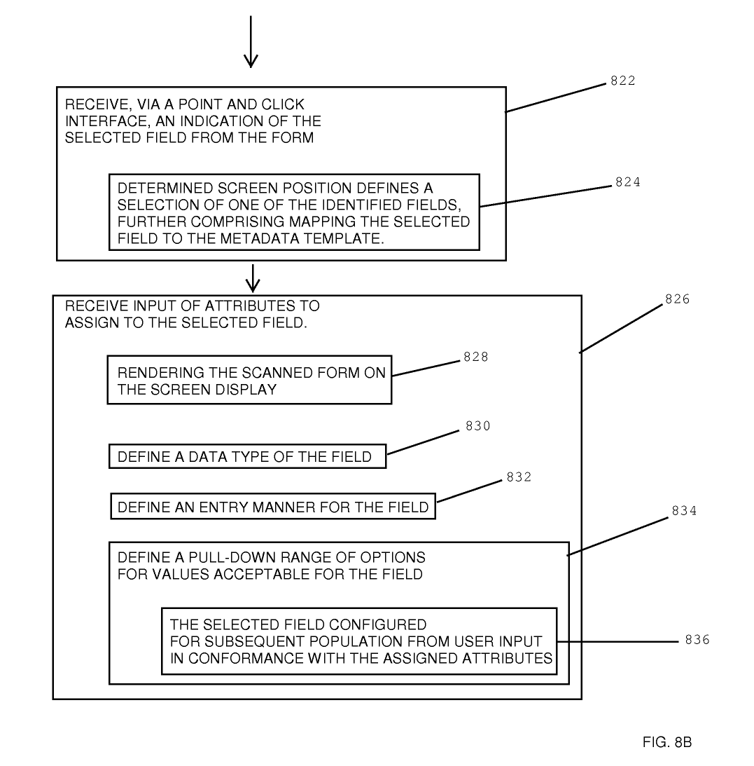

FIGS. 8a and 8b shows a flowchart of scanning and entering metadata for form development. Referring to FIGS. 1, 5-8a-8b, at step 800, a user scans a paper form 102 as used in business throughput context. The business context may be any enterprise where a paper medium of a common layout is routinely used for recording and transporting written information. In the particular configuration shown, a medical private practice example is illustrated, to depict the value of simulating the paper form on an electronic tablet form, however other private practice or larger corporate context may also benefit from the disclosed approach.

A check is performed, at step 802, to determining if a relevant domain of predetermined fields adapted for a specific context is available. Certain office contexts, such as particular medical specializations, often utilize a core set of fields that are routinely used. The predetermined fields initialize certain form fields 151 for convenience, however additional specific fields may also be added.

If a domain of predetermined fields 171 is available, then the application 112 generates metadata for the set of predetermined fields, in which the predetermined fields are based on data expected in the course of a context in which the paper form is invoked, as depicted at step 804. The generated metadata defines attributes for the predetermined fields, such that receiving the selection of the field further comprises associating the field with one of the predetermined fields. In the example scenario depicting a medical practice the metadata takes the form of a metadata template inclusive of predetermined fields based on a practice area of which the medical record is concerned. Mapping the form fields 140 (paper form) to the fields 151 (electronic form) includes determining which of the predetermined fields correspond to the identified fields on the paper rendering.

Invoking the scanner 104, the application 112 renders the raw scanned form 120 on a user display 113 from the paper rendering of the form, as disclosed at step 806 The user display 113 includes a window based GUI 116 (Graphical User Interface) for rendering the forms window 152, as shown at step 810 such that the forms window 152 is operable to display the scanned form 130 (step 812), and render the attributes window 154, depicted at step 814, in which the attributes window 154 displays attribute options (step 816) and receives input of attributes to assign to the selected field 151.

From the rendered GUI 116, the application 112 receives a selection of a field 151 based on the paper rendering of a form, as depicted at step 818. Based on position of the pointer 158, rendering of the scanned form outlines a region 162 for the field and specifies attributes for the field. In a particular configuration, the application 112 may identify a rendered field region 162 by examining visual features such as boxes and circles on the displayed form via edge and feature detection, or other machine vision approaches.

The application 112 receives, via a point and click interface, an indication of the selected field 151 from the form. The determined screen position defines a selection of one of the identified fields, further comprising mapping the selected field to the metadata template. The application 112 determines which of the predetermined fields correspond to the identified fields 140 on the paper rendering, as disclosed at step 820. This may be performed via the GUI 116 by selection and pointing of the designator box 162 and by clicking or creating a corresponding field 170 in the field list window 156. The GUI 113 provides mapping of the fields 140 from the rendered paper form 102 to the fields 151 of the (electronic) form 130, either by selection input or name or other matching with the predetermined fields. In this manner, a predetermined set of fields may be developed to suit particular domains for anticipating all or most of the fields 151, and allowing received input to supplement any specific fields needed. In the event of a field added to the domain, the application 112 determines that none of the predetermined fields correspond to the identified field 151, and adds a field entry 170 to the metadata fields corresponding to the identified field 151. Field mapping continues in an iterative manner until all intended fields from the paper form 102 are mapped to field 151 in the form 130 and reflected in a metadata field entry 170.

Following field 170 selection, the application assigns a set of attributes for the selected field 170. The application 112 receives a selection of the field 170, as depicted at step 822. The determined screen position defines the selected field, as depicted at step 824, and the application 112 receives attributes to assign to the selected field 170, as shown at step 826. This includes rendering the scanned form 130 on the screen display 113, as depicted at step 828, assigning the attributes may further include defining a data type of the field, as depicted at step 830, and defining an entry manner for the field, as shown at step 832. Entry manner defines the user action for field completion, such as buttons, pull downs, numeric, and free form text, to name several. The application 112 also defines a pull-down range of options for values acceptable for the field, in the case of range validation for numeric or enumerated types. The assigned attributes may also be based on a user selection of attributes from a pull-down menu, and vary based on appropriate attributes for the type of data defined by the field. Any suitable validation or processing of input fields may be performed, such as initiating additional fields upon population of a primary field, for example. The selected field 170 is therefore configured for subsequent population from user input in conformance with the assigned attributes, such as in a data entry application 212 designed to use the specified form. For example, in the medical office example shown, the form may be invoked on a tablet for recording patient diagnosis.

The forms 130 as generated herein are expected to be instantiated in a subsequent application 212 for data entry and transport based on interactive user input with the tablet or other mobile device 134. Accordingly, the approach disclosed herein involve subsequently rendering the scanned form 130 with the selected fields 151 and corresponding assigned attributes, and populating the field based on user input in conformance with the assigned attributes. A variety of mobile applications 212 operable for launch on execution on the mobile device 134 are therefore provided.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of gathering form data, comprising:
rendering a display of information items based on a spatial arrangement of the information items;
receiving a selection of a field based on the spatial arrangement; and
assigning a set of attributes for the selected field,
the selected field configured for subsequent population from user input in conformance with the assigned attributes.

2. The method of claim 1 further comprising:
rendering a scanned form on a user display from a paper rendering of the form, wherein the spatial arrangement is based on the paper form, the paper form employed in a repeatable process that uses the information items.

3. The method of claim 1 wherein the spatial arrangement is based on a templated layout that arranges the information items relative to other information items, the spatial arrangement defining a mental model retained by users, further comprising:
subsequently rendering the information items based on the mental model, the information items retaining the templated layout.

4. The method of claim 1 wherein the spatial arrangement is based on an electronic rendering of the information items, the electronic rendering based on a workflow sequence that defines a flow of information.

5. The method of claim 2 wherein the user display includes a window based GUI (Graphical User Interface), further comprising:
rendering a forms window, the forms window displaying the scanned form; and
rendering an attributes window, the attributes window displaying attribute options and receiving input of attributes to assign to the selected field.

6. The method of claim 5 wherein assigned attributes are based on a user selection of attributes from a pull-down menu.

7. The method of claim 6 wherein assigning the attributes further includes defining a data type of the field;
defining an entry manner for the field; and
defining a pull-down range of options for values acceptable for the field.

8. The method of claim 1 wherein the received selection is based on a screen display of a scanned form, further comprising:
rendering the scanned form on the screen display; and
receiving, via a point and click interface, an indication of the selected field from the form.

9. The method of claim 8 wherein the rendering of the scanned form outlines a region for the field and specifies attributes for the field.

10. The method of claim 9 further comprising identifying a rendered field region on the displayed form via edge and feature detection.

11. The method of claim 1 further comprising generating metadata for a set of predetermined fields, the predetermined fields based on data expected in the course of a context in which the spatial arrangement is invoked, the metadata defining attributes for the predetermined fields, wherein receiving the selection of the field further comprises associating the field with one of the predetermined fields.

12. The method of claim 2 further comprising:
subsequently rendering the scanned form with the selected field and corresponding assigned attributes; and
populating the field based on user input in conformance with the assigned attributes.

13. A method of generating a data entry form, comprising:
identifying, based on a paper rendering of a medical record, fields responsive to patient information;
mapping, for each of the identified fields, an association to metadata corresponding to the identified field;
determining, based on the paper rendering, a screen position of each of the identified fields;
receiving, from a screen position based on the defined position, the patient information corresponding to the paper rendering of the field; and
gathering, from a GUI display of each rendered field, data for populating the identified field.

14. The method of claim 13 further comprising:
defining a metadata template inclusive of predetermined fields based on a practice area of which the medical record is concerned; and
determining which of the predetermined fields correspond to the identified fields on the paper rendering.

15. The method of claim 14 wherein the determined screen position defines a selection of one of the identified fields, further comprising mapping the selected field to the metadata template.

16. The method of claim 14 further comprising:
determining that none of the predetermined fields correspond to the identified field; and
adding a field to the metadata fields corresponding to the identified field.

17. A server for generating forms for data entry, comprising:
a scanning interface for receiving a scanned form on a user display from a paper rendering of the form;
a Graphical User Interface (GUI) for rendering an image of the scanned form receiving a selection of a field based on the paper rendering of a form,
the GUI further operable for assigning a set of attributes for the selected field, the selected field configured for subsequent population from user input in conformance with the assigned attributes.

18. The server of claim 17 wherein the GUI is further configured to:
render a forms window, the forms window displaying the scanned form; and
render an attributes window, the attributes window configured for displaying attribute options and receiving input of attributes to assign to the selected field.

19. The server of claim 18 wherein assigning the attributes further includes defining a data type of the field;
defining an entry manner for the field; and
defining a pull-down range of options for values acceptable for the field.

20. The server of claim 17 wherein the received selection is based on a screen display of a scanned form, the GUI further configured to:
render the scanned form on the screen display; and
receive, via a point and click interface, an indication of the selected field from the form, the rendering of the scanned form outlining a region for the field and specifies attributes for the field.

21. The server of claim 17 further comprising an interface for receiving metadata for a set of predetermined fields, the predetermined fields based on data expected in the course of a context in which the paper form is invoked, the metadata defining attributes for the predetermined fields, wherein receiving the selection of the field further comprises associating the field with one of the predetermined fields.

22. The server of claim 17 further comprising an application interface, the application interface configured for:
subsequently rendering the scanned form with the selected field and corresponding assigned attributes; and
populating the field based on user input in conformance with the assigned attributes.

23. A computer program product on a non-transitory computer readable storage medium having instructions that, when executed by a processor, perform a method for generating data entry forms, comprising:
rendering a scanned form on a user display from a paper rendering of the form;
receiving a selection of a field based on the paper rendering of a form; and
assigning a set of attributes for the selected field,
the selected field configured for subsequent population from user input in conformance with the assigned attributes.
